(19) United States
(12) Patent Application Publication
(10) Pub. No.: US 2011/0235109 A1
(43) Pub. Date: Sep. 29, 2011

(54) IMAGE DISPLAY CONTROL DEVICE AND IMAGE FORMING APPARATUS INCLUDING THE SAME

(76) Inventor: Takeshi YAMAGUCHI, Osaka (JP)

(21) Appl. No.: 13/045,566

(22) Filed: Mar. 11, 2011

(30) Foreign Application Priority Data
Mar. 25, 2010 (JP) 2010-070037

(51) Int. Cl. G06F 3/12; G06F 17/00

(52) U.S. Cl. 358/1.15; 715/274

(57) ABSTRACT

A control unit includes a touch panel display capable of presenting preview representation of a multiple number of document images on a panel display. The touch panel display includes a function by which, when the paper is subjected to a binding process after printing document images on the paper, the preview images displayed on the display panel are arranged vertically or horizontally with respect to the display panel and displayed, in accordance with the binding position of the paper; and a function of switching the direction of scrolling preview images between the vertical direction and the horizontal direction with respect to the display panel.

This Nonprovisional application claims priority under 35 U.S.C. §119 (a) on Patent Application No. 2010-070037 filed in Japan on Mar. 25, 2010, the entire contents of which are hereby incorporated by reference.

### BACKGROUND OF THE INVENTION

(1) Field of the Invention

The present invention relates to an image display control device for use in an electrophotographic image forming apparatus such a copier, printer, facsimile machine or the like and an image forming apparatus including the control device, in particular, relating to an image display control device capable of displaying plural pages of document images in a preview representation as well as to an image forming apparatus including the same.

(2) Description of the Prior Art

Conventionally, in order to prepare text using word processing software there have been some applications with which when “print layout” or “viewing layout” is selected, pages of text images are displayed, one below the other in a vertical direction at any time without regard to the setting of “binding margins” and/or the “position of binding”.

Alternatively, there have been some other software applications with which when “two-page spread” display is selected as a page displaying mode, spreads of two pages that are placed side by side are arranged vertically.

As the prior art, there is a disclosed technique for printing scanned document image data in an integrated manner, in which scanned images of document data are displayed on a touch panel in the horizontal direction so that the sectioned pages can be selected in a lateral layout (or by horizontal scrolling) (see Patent Document 1).

Patent Document 1:
Japanese Patent Application Laid-open No. 2006-166220.

However, according to the aforementioned prior art, there occurs a case where correct two-page spread representation cannot be obtained depending on the position of binding when display of multiple pages is given by scrolling or frame switching in a vertical layout or a lateral layout (lateral spread when spread display is used) in an inflexible manner.

Further, when the status, at the time of printing on, a word processing application or other software is previewed, the pages of data to be output, that should be bound at the right side as a Japanese book may be displayed from top to bottom (from left to right in a case of a spread). In this case, when the displayed content is compared with the case where the actually printed pages are turned over to be read, the facing pages in a spread of the double-sided printing data for right-side binding may be displayed in reverse order or right side left, compared to the actual order of printed pages.

On the other hand, in reading pages of double-sided print data bound on the left side, when the page is turned over after reading the right-side page the gaze moves from the bottom right to the top left of the next left side page after turning over. In this while, the gaze moves from the bottom to top along the left edge of the next page. In the case of display, the gaze moves from right to left along the top edge of the next page, which markedly differs in sensation from when the printed matter is read.

### SUMMARY OF THE INVENTION

The present invention has been devised in view of the conventional problems discussed above, it is therefore an object of the present invention to provide an image display control device and an image forming apparatus including the control device which, in accordance with the position of binding, provides display of print preview images so that the user can see the preview images by moving their gaze in the same manner as when turning over the pages of the actual printed matter and hence can easily imagine the printout condition.

The first aspect of the invention resides in an image display control device comprising: a control screen on which document images are presented in preview representation; and, a display controller that has a function of presenting plural pages of document images on the control screen in preview representation and a function of displaying the plural pages of document images presented in preview representation in a vertically or horizontally scrolling manner, and is characterized in that the display controller includes: a function by which, when a plurality of pages of recording mediums with the plural pages of document images recorded thereon are bound, the plural preview images of the plural pages of document images displayed on the control screen are arranged vertically or horizontally with respect to the control screen and displayed, in accordance with the binding position of the recording medium; and a function of switching the scrolling direction of the plural preview images between the vertical direction and the horizontal direction with respect to the control screen.

In the second aspect of the invention, it is preferred that the display controller includes a function of scrolling the preview images in the direction crossing the side edge along which the recording mediums displayed as the preview images on the control screen are bound.

In the third aspect of the invention, it is preferred that the display controller includes a function of scrolling the preview images in the direction crossing the saddle binding line (the fold when the paper is folded along the saddle binding position) of the recording mediums displayed as the preview images on the control screen.

In the fourth aspect of the invention, it is preferred that the control screen includes a touch-control detector that detects a touch control on the control screen by the finger of a user, and, the touch-control detector has a function of scrolling the preview images in accordance with the indication of the scrolling direction of the preview images by the finger of the user.

The fifth aspect of the invention resides in an image forming apparatus comprising: an image display control device, and is characterized in that the image display control device includes: a control screen on which document images are presented in preview representation; and, a display controller that has a function of presenting plural pages of document images on the control screen in preview representation and a function of displaying the plural pages of document images presented in preview representation in a vertically or horizontally scrolling manner, and, the image display control device is the image display control device according to any one of the above first to fourth aspects.

According to the first aspect of the present invention, since the user can see preview images by moving their gaze in the same manner (for example, in a state where the printed matter is given as an expanded zigzag fold) as if the user in accordance with a binding position of the recording medium actually turns over the page of the printed matter with the binding position fixed, the user can easily imagine the condition of the finished printout.

According to the second aspect of the present invention, the user can see preview images by moving their gaze in the same manner as if the user actually turns over the page of the printed matter, hence the user is able to easily imagine the condition of the finished printout.

According to the third aspect of the present invention, the user can see preview images by moving their gaze in the same manner as if the user actually turns over the page of the printed matter, hence the user is able to easily imagine the condition of the finished printout.

According to the fourth aspect of the present invention, it is possible to easily turn preview pages in a similar feeling as if pages of the actual printed matter are turned over.

According to the fifth aspect of the present invention, since in printing out images in the image forming apparatus, the user can see preview images by moving their gaze in the same manner (for example, in a state where the printed matter is given as an expanded zigzag fold) as if the user actually turns over the page of the printed matter, it is possible to provide an image forming apparatus that enables the user to easily imagine the condition of the finished printout.

### BRIEF DESCRIPTION OF THE DRAWINGS

FIG. 1 is a perspective view showing the configuration of an image forming apparatus according to the embodiment of the present invention;

FIG. 2 is an illustrative view schematically showing the internal mechanisms of the image forming apparatus;

FIG. 3 is a functional block diagram showing a hardware configuration of the image forming apparatus;

FIG. 4 is an illustrative view showing the display regions of a touch panel display of the image forming apparatus;

FIG. 5 is an illustrative view showing an example of a screen displayed on the touch panel display;

FIG. 6 is an illustrative view showing a state where the preview region being displayed on the touch panel display is varied;

FIG. 7 is a block diagram showing a configuration of the touch panel display;

FIGS. 8a to 8c are illustrative views showing states where document images are displayed laterally in preview representation on the touch panel display;

FIGS. 9a to 9c are illustrative views showing states where document images are displayed vertically in preview representation on the touch panel display;

FIG. 10 is an illustrative view showing a state of document images in preview representation on the touch panel display when the vertical side edge on the left side of the printed paper is bound;

FIG. 11 is an illustrative view showing a state of document images in preview representation on the touch panel display when the vertical side edge on the right side of the printed paper is bound;

FIG. 12 is an illustrative view showing a state of document images in preview representation on the touch panel display when the top horizontal edge of the printed paper is bound;

FIG. 13 is an illustrative view showing a state of document images in preview representation on the touch panel display when the printed paper is bound along the vertical fold by saddle stitch binding and used as a left-bound booklet;

FIG. 14 is an illustrative view showing a state of document images in preview representation on the touch panel display when the printed paper is bound along the vertical fold by saddle stitch binding and used as a right-bound booklet;

FIG. 15 is an illustrative view showing a state of document images in preview representation on the touch panel display when the printed paper is bound along the horizontal fold by saddle stitch binding and used as a top-bound booklet; and,

FIG. 16 is a flow chart showing the procedural sequence for determining the method of arraying document images to be displayed on the touch panel display and the method of their arrangement, depending on the bound position of document images.

### DESCRIPTION OF THE PREFERRED EMBODIMENTS

The embodiment of the present invention will hereinafter be described with reference to the accompanying drawings.

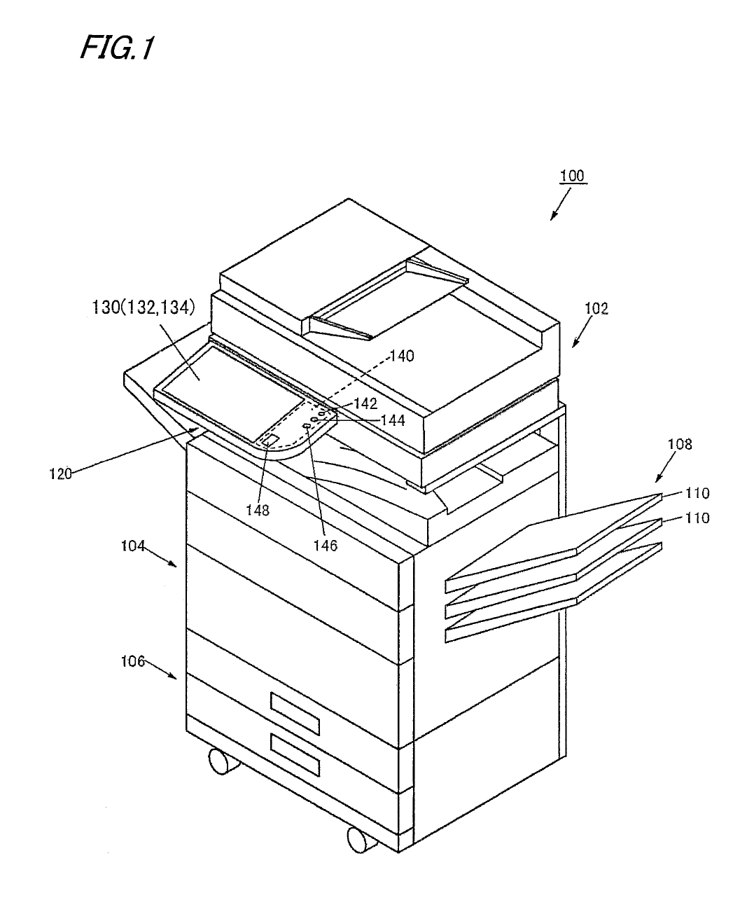

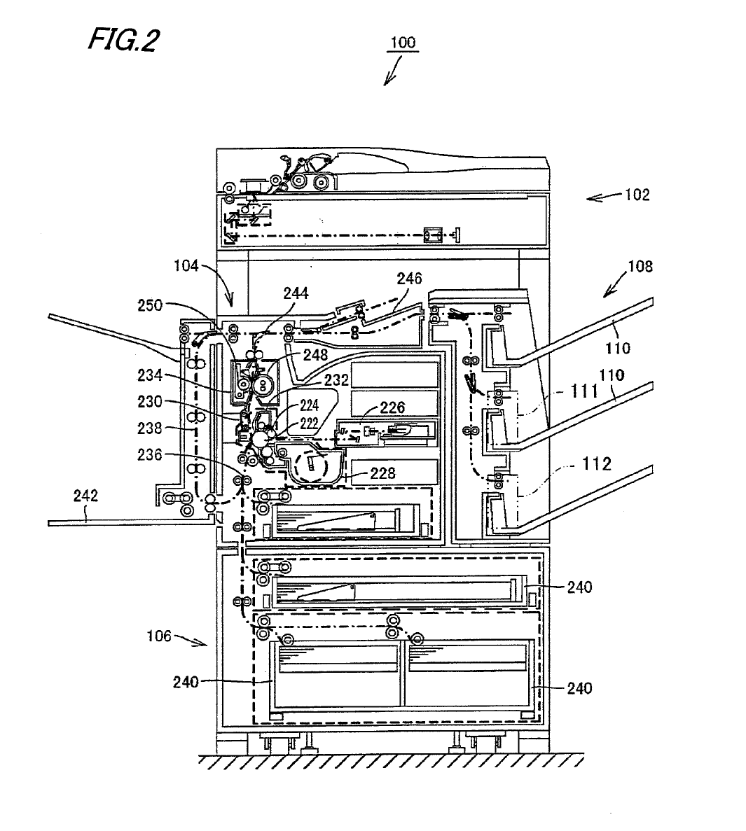

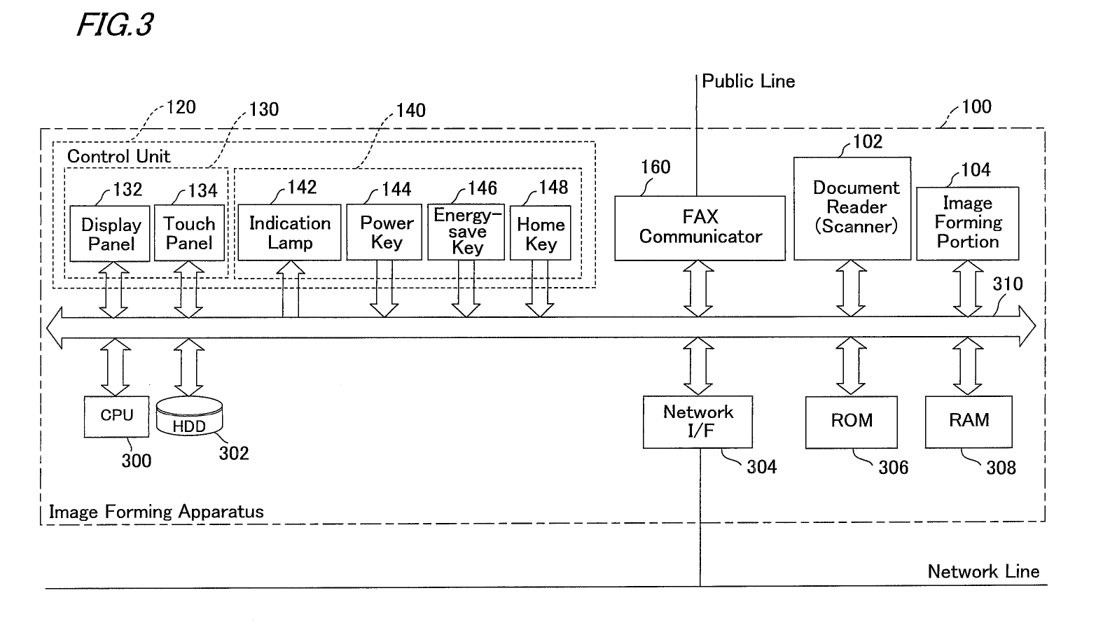

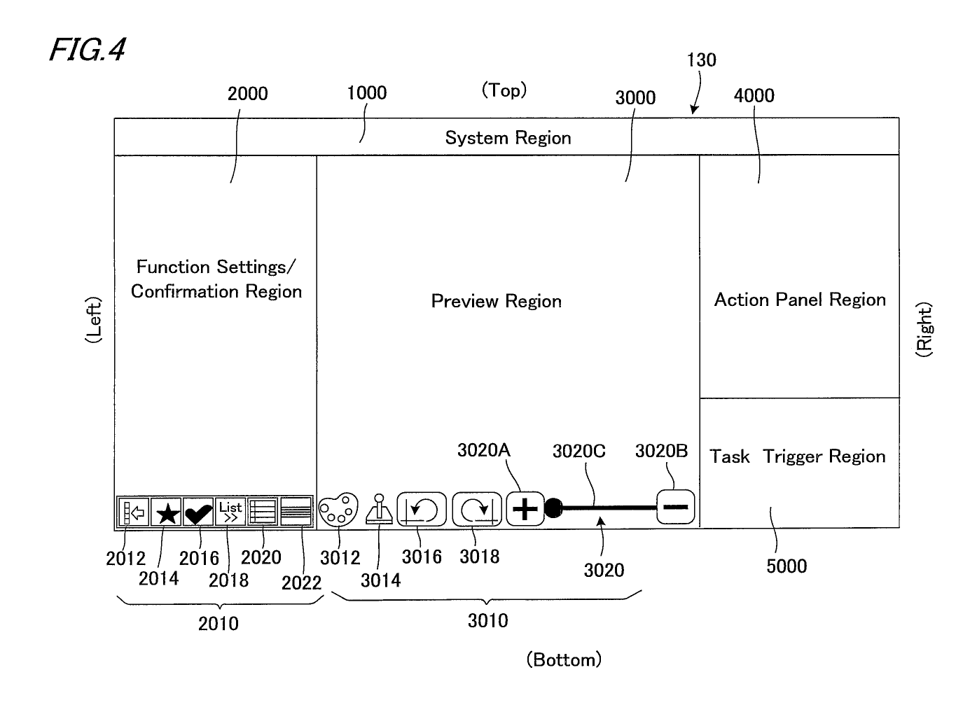

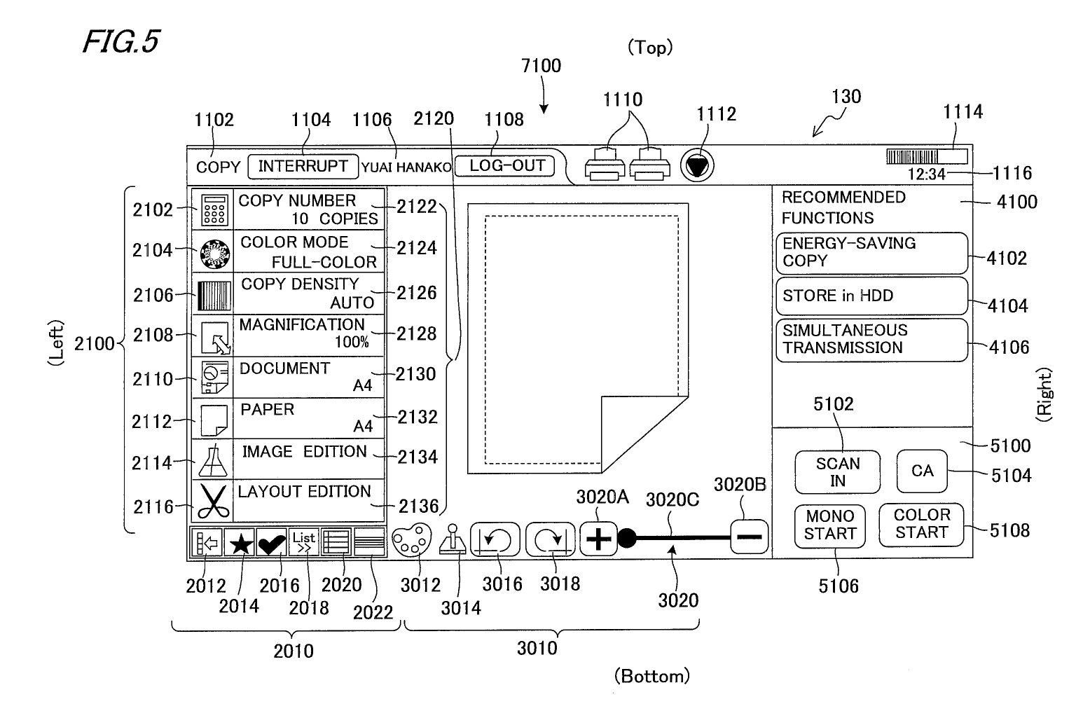

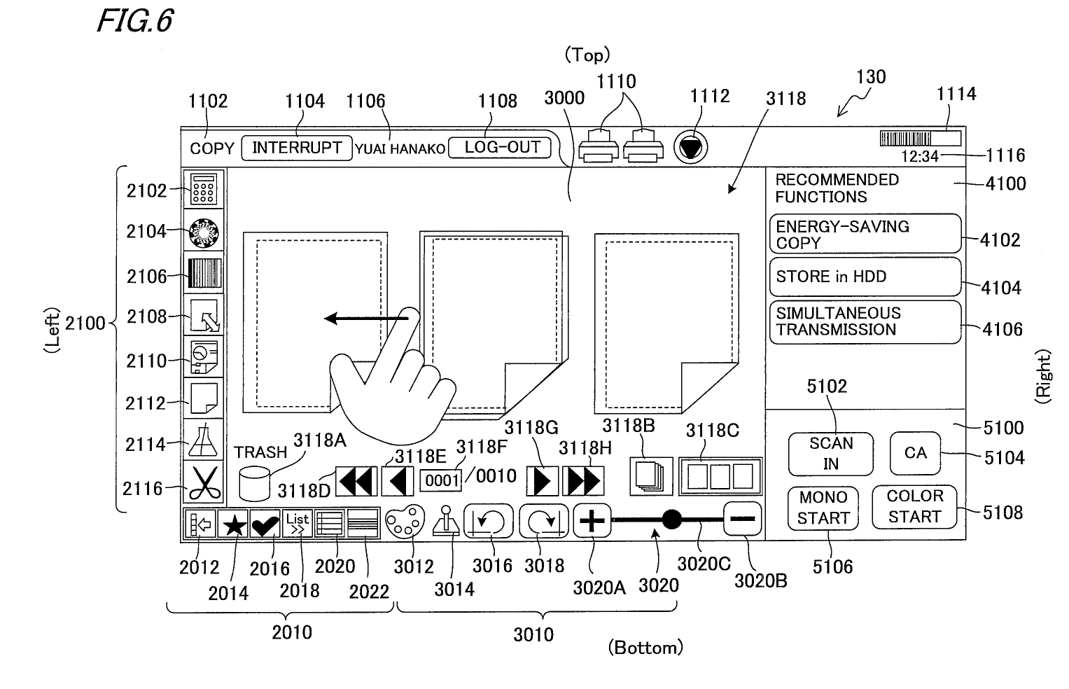

FIG. 1 shows one example of the mode for carrying out the invention and is an illustrative view showing the whole configuration of an image forming apparatus including an image display control device according to the embodiment of the present invention. FIG. 2 is an illustrative view schematically showing the internal mechanisms of the image forming apparatus. FIG. 3 is a functional block diagram showing a hardware configuration of the image forming apparatus. FIG. 4 is an illustrative view showing the display regions on a touch panel display of the image forming apparatus. FIG. 5 is an illustrative view showing an example of a screen displayed on the touch panel display. FIG. 6 is an illustrative view showing a state where the preview region being displayed on the touch panel display is varied.

An image forming apparatus 100 according to the embodiment of the present invention includes, as shown in FIG. 1, a control unit (image display control device) 120 having a touch panel display (display controller) 130 capable of making preview representation of multiple pages of document images on a display panel (control screen) 132.

Description herein will be described on the assumption that the multiple document images displayed on display panel (control screen) 132 are those captured by the document reader of image forming apparatus 100, but the multiple document images may be images to be formed on recording paper by the image forming portion.

Image forming apparatus 100 is a kind of an image processing apparatus. The image display control device according to the present invention is applicable to image processing apparatuses and electronic appliances other than the image forming apparatuses of this kind.

Further, image forming apparatus 100 includes a plurality of operational modes, and is equipped with a display device for displaying information for each operational mode. The display device is preferably constructed so as to be able to display information the user wants in a user friendly manner even if the user does not remember that screen configuration when the operational mode is changed over.

Here, image forming apparatus 100 includes a touch panel display (control screen) that can be controlled by both gesture control and touch control other than gesture control, but the image forming apparatus may use a touch panel display that can be controlled by touch control only. Alternatively, the image forming apparatus may include a display panel that cannot be touch-controlled but can display only and keys for control.

Here, gesture control means controls that are related to various kinds of movements of fingers in combination with GUI (Graphic User Interface), such as responses in accordance with the distance moved and speed of the fingers, double-tapping, the moving fingers trace and the like that are given with meanings.

This image forming apparatus 100 forms images on recording paper based on electrophotography.

Image forming apparatus 100 includes, as its operation modes, copy mode, facsimile mode (FAX mode), document filing mode (a mode in which scanned images are stored in a storage inside the image forming apparatus) and mail mode (a mode in which scanned images are transmitted in the form of an attachment file to an e-mail). This image forming apparatus 100 may further have a network printer mode.

The image forming apparatus 100 changes the display screen every time the operation mode is switched. Further, the printing mechanism is not limited to electrophotography.

To being with, image forming apparatus 100 will be described.

Image forming apparatus 100 includes a document reader 102, an image forming portion 104, a paper feed portion 106, a paper output processor 108 and a control unit 120.

Control unit 120 is formed of a touch panel display 130 and a display control portion 140.

Touch panel display 130 is comprised of a display panel 132 of a liquid crystal panel or the like and a touch panel (touch control detecting means) 134 that is laid over display panel 132 to detect the positions the user presses with fingers.

Display control portion 140 includes an indication lamp 142, a power key 144, an energy-save key 146 and a home key 148 that resets the display content of touch panel display 130 to the home screen for operational mode selection.

In this way, image forming apparatus 100 has touch panel display 130 as a main control device and also has a display control portion 140 that includes the hardware keys and indication lamp.

The keys (power key 144, energy-save key 146 and home key 148) on display control portion 140 are given as hardware buttons, in contrast to software buttons formed by touch panel display 130.

Note that image forming apparatus 100 should not be limited to that including display control portion 140 of this kind, but may be provided with touch panel display 130 only. That is, it will work as long as the initial screen of the selected operational mode can be actuated when the user selects a mode on the home screen displayed on touch panel display 130. The operational modes of this image forming apparatus 100 will be described.

### (Copy Mode)

The operation of the copy mode of image forming apparatus 100 will be described.

In this copy mode, image reader (which will be referred to hereinbelow as “scanner”) 102 and image forming portion 104 operate mainly.

A document placed on a document placement table is captured as image data by scanner 102 and the read image data is input to a CPU 300 of a microcomputer etc. shown in FIG. 3, where the image data undergoes various kinds of image processing, and the processed image data is output to image forming portion 104.

As shown in FIG. 2, image forming portion 104 is a mechanism that prints images of documents given as image data onto recording mediums (recording paper in most cases), including a photoreceptor drum 222, a charging device 224, a laser scan unit (which will be referred to hereinbelow as “LSU”) 226, a developing device 228, a transfer device 230, a cleaning unit 232, a fixing unit 234, an unillustrated charge eraser and other devices.

Also, image forming portion 104 is provided with a main feed path 236 and a reverse feed path 238. The recording paper fed from paper feed portion 106 is conveyed along main feed path 236. Paper feed portion 106 draws recording paper, one sheet at a time, from a stack of recording paper, held in a paper feed cassette 240 or set on a manual feed tray 242 and delivers the recoding paper to main feed path 236 of image forming portion 104.

In the course of the recording paper being conveyed along main feed path 236 of image forming portion 104, the recording paper passes through and between photoreceptor drum 222 and transfer device 230 and then passes through fixing device 234 to perform printing for the recording paper.

While photoreceptor drum 222 rotates in one direction, its surface is cleaned by cleaning device 232 and the charge erasing device, then uniformly electrified by charging device 224.

Laser scan unit 226 modulates the laser beam based on the image data to be printed and repeatedly scans the laser beam over the photoreceptor drum 222 surface in the main scan direction, to form an electrostatic latent image on the photoreceptor drum 222 surface.

Developing unit 228 supplies toner to the photoreceptor drum 222 surface and develops the electrostatic latent image to form a toner image on the photoreceptor drum 222 surface.

Transfer device 230 transfers the toner image on the photoreceptor drum 222 surface to the recording paper which passes through the nip between the transfer device 230 and photoreceptor drum 222.

Fixing device 234 includes a heat roller 248 for heating recording paper and a pressing roller 250 for pressing recording paper. The recording paper is heated by heat roller 248 and pressed by pressing roller 250 so that the toner image transferred to the recording paper is fixed to the recording paper. A heater in the heat roller is heated by the power supplied to this fixing unit 234 so as to control and keep heat roller 248 at a temperature suitable for fixing. When the apparatus enters the energy saving mode, for instance the power supplied to this heater is stopped or cut down.

Arranged at the junction between main feed path 236 and reverse feed path 238 is a branch claw 244. When printing is performed only on one side of recording paper, branch claw 244 is positioned so as to lead the recording paper from fixing device 234 to a paper output tray 246 or paper output processor 108.

When printing is performed on both sides of recording paper, branch claw 244 is rotated in the predetermined direction so that the recording paper is once conveyed toward the paper output tray 246 side. Then, the paper is switched back and conveyed toward reverse feed path 238. The recording paper then passes through reverse feed path 238 and is inverted upside down and fed to main feed path 236 again. The recording paper is once again printed on its rear side in the course of main feed path 236 and lead to paper output tray 246 or paper output processor 108.

The recording paper thus printed is lead to paper output tray 246 or paper output processor 108 and discharged to either paper output tray 246 or each of paper output trays 110 of paper output processor 108.

In paper output processor 108, a plurality of recording sheets are sorted and discharged to individual paper output trays 110, and/or each set of recording sheets is punched or stapled. For example, when multiple copies of printed documents are prepared, the printed recording sheets are sorted and discharged to paper output trays 110 so that each set of recording paper is allotted to different paper output tray 110 and is punched by a punching unit 111 or stapled by a stapling unit 112 to prepare individual printed matter.

### (Facsimile Mode)

Next, the operation in facsimile mode will be described.

In this facsimile mode, the transmitting operation is mainly effected by document reader (scanner) 102 and a FAX communicator 160, as shown in FIG. 3. The receiving operation is mainly effected by FAX communicator 160 and image forming portion 104.

### (Transmitting Operation)

The transmitting operation is performed by the steps of: designating the facsimile mode, reading image data from a document placed on the document placement table by means of document reader 102, supplying the read image data to CPU 300 made up of a microcomputer etc. shown in FIG. 3 where the image data is subjected to various kinds of image processes, and outputting the thus obtained image data to the FAX communicator (FAX communicator 160 in FIG. 3).

As shown in FIG. 3, FAX communicator 160 of the transmission side image forming apparatus 100 connects the selected transmitter side line to the designated destination, converts the image data into communication data conforming to the facsimile communication standard and transmits the communication data to the receiver side facsimile machine (e.g., image forming apparatus 100 having a facsimile function).

### (Communication Operation)

When connection of the line is established, FAX communicator 160 of image forming apparatus 100 on the receiver side detects a communication request signal from FAX communicator 160 of image forming apparatus 100 on the transmitter side and sends a response signal. Then, for example, FAX communicators 160 on both the transmitter and receiver sides exchange facsimile performance information of their own with each other and determine the communication rate and coding and code correction scheme of the image data within the available maximum capacity to set up a modem communication scheme. The data is transmitted based on the determined communication scheme, from FAX communicator 160 of image forming apparatus 100 on the transmitter side to FAX communicator 160 on the receiver side. When data transmission is ended, the line is cut off.

### (Receiving Operation)

The FAX communicator 160 of image forming apparatus 100 on the receiver side converts the received data into image data and sends the data to image forming portion 104. Here, the received data may be converted into image data by image forming portion 104. Image forming portion 104 prints images of documents represented by the image data converted from the received data, onto recording paper, in the same manner as the above-described operation in copy mode.

Next, the control block configuration of image forming apparatus 100 will be described with reference to the drawings.

As shown in FIG. 3, image forming apparatus 100 includes: control unit 120 that allows the user to set copy mode and facsimile mode; a ROM 306 for storing programs etc.; a hard disk 302 serving as a non-volatile storage area that can hold programs, data and the like even if the power is cut off; and a RAM (Random Access Memory) 308 that offers a storing area when a program is executed.

Image forming apparatus 100 further includes: a bus 310 connected to image reader 102, image forming portion 104, FAX communicator 160, control unit 120, ROM 306, hard disk 302 and RAM 308; and CPU 300 that is connected to bus 310 to realize general functions of an image forming apparatus.

Hard disk 302 stores files of image data of documents scanned by the image forming apparatus 100. Hard disk 302 also holds (stores) initial screen data for each operational mode. The files and data stored in hard disk 302 can also be recorded in ROM 306.

Stored in ROM 306 are programs, data and the like necessary for controlling the operation of image forming apparatus 100. As the data stored in ROM 306 with the programs, the initial screen data for each operational mode may be stored. CPU 300 controls image forming apparatus 100 in accordance with the programs and data stored in ROM 306 and performs control associated with each function of image forming apparatus 100.

As shown in FIG. 3, a public line for exchange of image data is connected to FAX communicator 160 of this image forming apparatus 100 while a network line is connected to a network interface 304. This network line may be connected to a computer etc. that uses this image forming portion 100 as a network printer or may be connected via the Internet to a computer etc. that is designated by a URL (Uniform Resource Locator). When connected to the Internet in this way, the image forming apparatus 100 can obtain the necessary information by way of the Internet.

RAM 308 offers a function as a working memory for temporarily recording the result of the operation and processing by CPU 300 and a function as a frame memory for recording image data.

Control of image reader 102, image forming portion 104, touch panel display 130 and display control portion 140 forming control unit 120, ROM 306, hard disk 302 and RAM 308 is performed by CPU 300 executing predetermined programs. Here, control unit 120 communicates with CPU 300 by way of an input/output interface.

Control unit 120 is given as a board-like panel that is tilted so as to allow the user ease of view. Control unit 120 includes touch panel display 130 in the left area and display control portion 140 (including indication lamp 142 and hardware buttons, namely, power key 144, energy-save key 146 and home key 148) in the right area on the top thereof. Touch panel display 130 and display control portion 140 are integrally provided in control unit 120.

As described above, this touch panel display 130 is formed of display panel 132 and touch panel 134 that is laid over display panel 132.

Displayed on display panel 132 are the home screen for selection of the operational mode of this image forming apparatus 100, the current status of this image forming apparatus 100, the status of destination selection, job processing status and the like.

Displayed on the display area of display panel 132 are selection buttons as software keys. When the displayed area of a selection button is pushed by a finger, touch panel 134 detects the pushed position. Then, the position on which touch panel 134 is pressed is compared with the positions of selection buttons so as to perform selection of an operational mode of image forming apparatus 100, functional setting, operational instructions, and the like. In addition to this touch control (command input control based on the position of the user's pressing), this image forming apparatus 100 also supports the above-mentioned gesture control (command input control based on the trace of user's control motion).

Further, indication lamp 142 of display control portion 140 is made up of a LED (Light Emitting Diode) for instance and is controlled by CPU 300 so as to turn on/off (flash on and off). When the user presses down power key 144 that is provided separately in addition to the main power switch, this image forming apparatus 100 comes out of standby mode (in which, for example, only fax reception is permitted with the main power turned on) to active mode so that the whole operational modes of this image forming apparatus 100 can be used. Indication lamp 142 comes on in link with this status Further, when a predetermined period has elapsed without receiving any user input, or when the user presses energy-save key 146, this image forming apparatus 100 comes out of active mode into energy save mode so that only part of the operational modes of image forming apparatus 100 are operational. Indication lamp 142 flashes on and off in link with this status Further, when the user presses energy-save key 146 in this energy save mode, the image forming apparatus 100 comes out of energy save mode into active mode. Home key 148 is a hardware key for retuning the display of touch panel display 130 into the initial condition (home screen). It is noted that the operations when power key 144, energy-save key 146 and home key 148 are pressed should not be limited to these.

The hardware keys on display control portion 140 (power key 144, energy-save key 146 and home key 148) may be embedded with a key lamp controlled by CPU 300 so as to turn on/off (/flash). For example, this key lamp may be a round type key ring-like lighting or center lighting. This key lamp turns on at the timing that the hardware key is permitted to use as a control device (at the timing that operation is performed when the hardware key is used).

Image forming apparatus 100 has the aforementioned two operational modes (copy mode and facsimile mode). Software buttons for function settings in each operational mode are displayed on touch panel display 130, and also the preview as the on-screen form of forming images, keys for destination setting and the like are displayed as necessary.

When the operational mode is different from that which the user wants, touch panel display 130 displays another screen. In order for the user to easily find the information the user requests even in such a case, touch panel display 130 is divided into multiple regions (which also are given in a size variable manner) so as to display necessary information in each region.

In particular, in this image forming apparatus 100, when one operational mode is selected on the home screen of touch panel display 130 provided as the main display control device, the initial screen of the operational mode is displayed.

In this initial screen, (1) the basic layout is formed of five areas, namely “system region”, “function selecting region”, “preview region”, “action panel region” and “task trigger region”, which are appropriately arranged, so that the user is able to easily perform input of settings from top left to bottom right (in the same manner as the user moves their gaze and fingers in the conventional machine which is not provided with a large scale touch panel display 130). Further, (2) the concept of the displays of the five regions is consistent in all operational modes, so that the user is able to operate without confusion when another operational mode is used. The following description will be given on the configuration of the basic layout.

The basic layout in touch panel display 130 will be described with reference to the drawings.

As shown in FIG. 4, the basic layout of touch panel display 130 is designed in the laterally long touch panel display 130 such that a system region 1000 is arranged at the topmost part, a preview region 3000 in the center of the screen, a function settings/confirmation region 2000 on the left side of preview region 3000, an action panel region 4000 on the upper right part of preview region 3000, and a task trigger region 5000 on the lower right of preview region 3000. Here, the laterally long touch panel display 130 is formed of, for example, 1024 pixels wide×600 pixels high. Further, function settings/confirmation region 2000 will be described hereinbelow as function selecting region 2000.

It is noted that the number of regions in touch panel display 130 should not be limited to five. Also, the horizontal arrangement should not be limited so that the horizontal arrangement may be reversed right side left, for example, depending on the user's dominant hand. Further, the position of system region 1000 may be disposed at the lowermost part. Alternatively, the system region 1000 may be undisplayed depending on the status or settings.

System region 1000 displays the current status of this image forming apparatus 100, e.g., the title of the operational mode in control and the status and conditions of image forming apparatus 100. For example, displayed in system region 1000 are the name of operational mode, the cut-in key, the log-in user name, the job status in progress, the usage status of built-in memory, time and the like.

In function selecting region 2000, settings in each function, display switching, function selecting menu (icons, buttons, etc.) operated by user to confirm settings are variably displayed in a selected display style, in icon mode, regular mode or express mode.

In icon mode, only icons for function setting are displayed in function selecting region 2000 so as to maximize the size of preview region 3000.

In express mode, the display of function selecting region 2000 is enlarged so as to allow the user to set the function all at once though the size of preview region 3000 is minimized.

In regular mode, preview region 3000 is sized between that in the icon mode and that in the express mode while in function selecting region 2000 the text of function titles are displayed together with functional setting icons.

This icon mode, regular mode and express mode are switched from one to another based on user control. That is, the size of preview region 3000 is modified and displayed in accordance with user control. In this way, since icons are able to give information to the user by using limited area, it is preferable that every function is given with an icon so as to enlarge the display of preview region 3000.

This function selecting region 2000 includes at its bottom a group of select buttons 2010 for switching the display style in function selecting region 2000.

Arranged in the group of select buttons 2010 are an icon mode entering button 2012 for displaying function selecting region 2000 in icon mode, a favorite button 2014 for displaying the functions registered as “favorites”, a check button 2016 for displaying the functions whose settings have been modified, a list button 2018 for displaying a list of all the functions that can be designated in the selected operation mode, a regular mode entering button 2020 for displaying function selecting region 2000 in regular mode, and an express mode entering button 2022 for displaying function selecting region 2000 in express mode.

Here, when there are many pieces of information to be displayed in function selecting region 2000, the information is displayed in this function selecting region 2000, in a vertically scrolling manner. In this case, this group of select buttons 2010 is not scrolled but constantly displayed in the bottom-most portion of function selecting region 2000.

Preview region 3000 displays the image of output pages of the (finished) document. The image is displayed using dummy data or scanned data, and the displayed image in preview region 3000 is revised every time the user changes the finish. There are two modes of displaying the finish in this preview region 3000: the display of the final preview with a dummy image in virtual mode before scanning and the display of the final preview with actual images in scan-in mode after scanning. The virtual mode further has two types, before setting documents and after setting documents.

At the bottom of this preview region 3000 there is a group of preview select buttons 3010 for changing the display style in preview region 3000.

The group of preview select buttons 3010 includes a rotate-left button 3016 for rotating the image left 90 degrees and a rotate-right button 3018 for rotating the image right 90 degrees and a zoom bar 3020. Other than these, for example, a change color button 3012 and preview control button 3014 are arranged.

With this, when rotate-left button 3016 is touched once, the preview rotates 90 degrees left. When the button is touched twice, the preview is rotated 180 degrees left (inverted upside down). Alternatively, when the image of the finished document displayed in the preview region is gesture-controlled (by rotating the document image 180 degrees counterclockwise with the fingertip), the preview is rotated 180 degrees left or inverted upside down.

When rotate-right button 3018 is touched once, the preview rotates 90 degrees right. When the button is touched twice, the preview is rotated 180 degrees right (inverted upside down). Alternatively, when the image of the finished document displayed in the preview region is gesture-controlled (by rotating the document image 180 degrees clockwise with the fingertip), the preview is rotated 180 degrees right or inverted upside down.

When the (+) button 3020A of zoom bar 3020 is touched, or when bar 3020C is gesture-controlled (by the “drag or flick” gesture) toward the (+) button 3020A, the preview image is enlarged. Alternatively, when the image of the finished document displayed in the preview region is gesture-controlled (on the document image by the “pinch out/pinch open” gesture with fingertips), the preview image is enlarged. Here, the “drag” gesture is an action of moving the finger. The “flick” gesture is a swiping action of the finger. The “pinch out/pinch open” is an action of spreading the two fingertips apart.

When the (−) button 3020B of zoom bar 3020 is touched, or when bar 3020C is gesture-controlled (by the “drag or flick” gesture) toward the (−) button 3020B, the preview image is reduced. Alternatively, when the image of the finished document displayed in the preview region is gesture-controlled (on the document image by the “pinch in/pinch close” gesture with fingertips), the preview image is reduced. Here, the “pinch in/pinch close” is an action of bringing the two fingertips together.

When there are many pages of document images to be displayed in preview region 3000, touchable displayed page select buttons (page number input buttons, page up and down buttons, single page display button and multiple page display button, etc.) may be displayed. In this case, it is also possible to turn over or return the page of the document to be previewed by gesture control of the document image (a “flick” gesture). Further, when the document image to be displayed in preview region 3000 is large, scroll bars that can be touched or gesture-controlled may be displayed.

Action panel region 4000 displays information such as hint, advice and suggestion for operation and control. Display in this action panel region 4000 is given such that when a particular function is selected by a certain user, the functions associated with the subject function may be displayed, another function as to the subject function may be displayed in a purpose-oriented manner, or the function that was selected in the past in combination with the subject function by the same user or a user of the group to which this user belongs may be displayed as a “recommended function”.

Task trigger region 5000 displays trigger items that the user operates in order to actually cause the image forming apparatus 100 to operate after all the settings in the operational mode have been completed. An example is the start button (software button) for starting the operation. Here, since information on a lack of a consumable supply is also related to the unfeasibility of the task in the operational modes needing a printing process (other than fax transmission), this should be also displayed in this “task trigger region”.

In this case, it is preferable that the start button is displayed only when the start button can be pressed down. The condition in which the start button can be pressed down, means a state where all settings have been completed and none of consumable supplies (recording paper and toner) will run short in the case of an operational mode needing a printing operation or a state where all the transmission parameters including destination have been set in the case of a fax mode (transmission) operation as the operational mode needing no printing.

The layout of these five regions is not changed even if the operational mode is switched from one to another (in the initial screen of any operational mode). Further, each region may change in size, expanding or contracting in the horizontal (longitudinal) direction of the screen of touch panel display 130 as in the case where the display of function selecting region 2000 (and preview region 3000) is switched between icon mode, regular mode and express mode.

The layout of the five regions is designed in light of the user interfaces in conventional machines, by directing attention to user's path of gaze and control. This arrangement leads the user to perform settings by moving their gaze from top left to bottom right and moving their input action (fingers of the dominant hand) from top left to bottom right.

In this arrangement, for switching the operational mode from one to another, the user presses down home key 148 (FIG. 3) and selects another operational mode on the home screen. In this way, it is possible to change operational mode by way of the home screen.

### (Initial Screen Display Operation in Copy Mode)

When copy mode is selected, the initial screen for copy mode is displayed on touch panel display 130 using copy mode initial screen data loaded from hard disk 302 (FIG. 3) or the like.

In this occasion, a copy mode initial screen 7100 is displayed for example, on touch panel display 130, as shown in FIG. 5. Copy mode initial screen 7100 displays information using the five divided regions laid out as described above.

In system region 1000 (FIG. 4) of copy mode initial screen 7100, areas 1102, 1104, 1106, 1108, 1110, 1112, 1114 and 1116 are laid out as shown in FIG. 5.

Area 1102 denotes the operational mode being selected (copy mode in this case).

Displayed in area 1102 is the name and/or icon of the operational mode.

It is preferred that a pulldown menu showing operational modes is displayed so as to allow for switching of operational mode when this area 1102 is touch-controlled, tapped or double-tapped (the same in other operational modes).

Area 1104 displays sub information entailing the selected operational mode.

In area 1104 a cut-in key (software button) is displayed as sub information. When this cut-in key is touch-controlled, tapped or double-tapped, a cut-in process can be actuated in copy mode.

Area 1106 displays the log-in user name.

In area 1108 a log-out button (software button) is displayed.

Area 1110 displays the status of the job in progress.

Area 1112 displays buttons (software buttons) related to job status.

That is, area 1112 displays the status of the job in progress with an icon. This job status is touch-controlled, tapped or double-tapped, the job status information is displayed in detail. It is further preferable that a button for suspending the selected job and the like are displayed in area 1112.

Area 1114 displays the communication status and area 1116 displays the current time.

Displayed in function selecting region 2000 (FIG. 4) on copy mode initial screen 7100 are a function selecting menu 2100 that allows the user to select in copy mode and a group of select buttons 2010 described above. In the screen shown in FIG. 5, the function select menu is displayed in regular mode.

As shown in FIG. 5, the function select menu displayed in regular mode is composed of a group of icons 2100 and a group of texts 2120.

As the function select menu displayed in function selecting region 2000, texts 2122, 2124, 2126, 2128, 2130, 2132, 2134 and 2136 are displayed.

Text 2122 shows an icon 2102 for setting the number of copies and its set content.

Text 2124 shows an icon 2104 for setting color mode and its set content.

Text 2126 shows an icon 2106 for setting copy density and its set content.

Text 2128 shows an icon 2108 for setting copy magnification and its set content.

Text 2130 shows an icon 2110 for setting the document type and its set content.

Text 2132 shows an icon 2112 for setting the paper type and its set content.

Text 2134 shows an icon 2114 for image edition and its set content.

Text 2136 shows an icon 2116 for layout edition and its set content.

Here, it should be noted that a greater number of items can be also displayed in the function setting menu, in a vertically scrolling manner with the position of select buttons 2010 fixed. In this case, the displayed items inclusive of hidden items above and below, can be changed from one to another by any of touch control (scroll control) and gesture control (flick control in the vertical direction).

Here, the image edition is edition for one page document, and includes, as a lower-layered menu, frame deletion, printing menu, watermark, user stamp and the like. The layout edition is edition for multiple pages of documents, and includes, as a lower-layered menu, page integration, binding margins, page change, centering and the like. Subordinates menus under these will be displayed on touch panel display 130 by touching, taping or double-tapping icons 2102 to 2116 or texts 2112 to 2136.

Arranged in preview region 3000 (FIG. 4) on copy mode initial screen 7100 are a document output (finish) image 3100 and a group of preview select buttons 3010 stated above. In this arrangement, dummy data or scanned data is used to display image 3100, and the image 3100 is modified and displayed on preview region 3000 every time the function setting menu in function selecting region 2000 is changed (the preview display is changed by user).

Displayed in action panel region 4000 (FIG. 4) on copy mode initial screen 7100 is information such as hint, advice and suggestion for copying operation. Here, recommended functions in the copy mode that the user selects are displayed as shown in FIG. 5. In this case, action panel region 4000 includes an area 4100 that indicates the content of the displayed information and areas 4102 to 4106 that are displayed with text showing recommended functions and serves in themselves as software buttons.

When area 4102 is touch-controlled, tapped or double-tapped, a pulldown menu of further detailed information for energy-saving in copying is displayed. In this case, for example, a software button for entering the function setting screen for duplex copying is displayed with text “Duplex printing will save paper”, a software button for entering the function setting screen for page integration with text “Printing multiple documents integrally will save paper”, and a software button for entering the function setting screen for saddle stitch binding with text “Printing can be done so as to bind the paper as a booklet”.

Displayed in task trigger region 5000(FIG. 4) on copy mode initial screen 7100 is a group of command buttons 5100. These command buttons 5100 include a scan-in key (software button) 5102, a clear-all key (software button) 5104, a monochrome start key (software button) 5106 and a color start key (software button) 5108.

Scan-in key 5102 is a key for causing image forming apparatus 100 to scan a document to obtain image data.

Clear-all key 5104 is a key for clearing the set functions.

Monochrome start key 5106 is a key for causing image forming apparatus 100 to scan a document and perform monochrome copying.

Color start key 5108 is a key for causing image forming apparatus 100 to scan a document and perform color copying.

In this way, when the user inputs a request in copy mode initial screen 7100 displayed with information in five-divided regions, a copying process is effected in accordance with the request.

Next, description will be made on the switching operation of preview pages when preview region 3000 (FIG. 4) is enlarged with function selecting region 2000 (FIG. 4) displayed in icon mode.

When the user flicks left the preview display screen in which a preview image 3118 is displayed as shown in FIG. 6, the input trace is analyzed. In this case, the gesture control by this user is analyzed as a request for turning over the page, and a revised preview image including another page that has not been displayed and corresponds to the direction of the flick is displayed.

It is also possible to change the pages to be displayed in the preview image by touching a page forward button 3118G, page fast forward button 3118H, page reverse button 3118E or page fast reverse button 3118D. It is also possible to change the pages to be displayed in the preview image by touching a direct pagination button 3118F and directly inputting the page number the user wants to jump.

In this way, when function selecting region 2000 is displayed in icon mode, preview region 3000 is enlarged so that it is possible to display the preview image so as to improve user' visual recognition and user controllability. In particular, it is possible to switch the preview display up to the preview image the user wants by touch control or gesture control, and display a desired preview image.

Here, designated at 3118A in FIG. 6 is a trash icon. When a selected page is dragged to this trash icon 3118A, the page can be deleted.

When a single page display icon 3118B is pressed down, the preview image with, for example three pages displayed, is changed to one page representation (in this case one page is displayed in a large scale). When a multiple page display icon 3118C is pressed down, the preview image with, for example, one page displayed, is changed to three page representation.

Next, the configuration of control unit 120(FIGS. 1 and 3) will be described in detail with reference to the drawings.

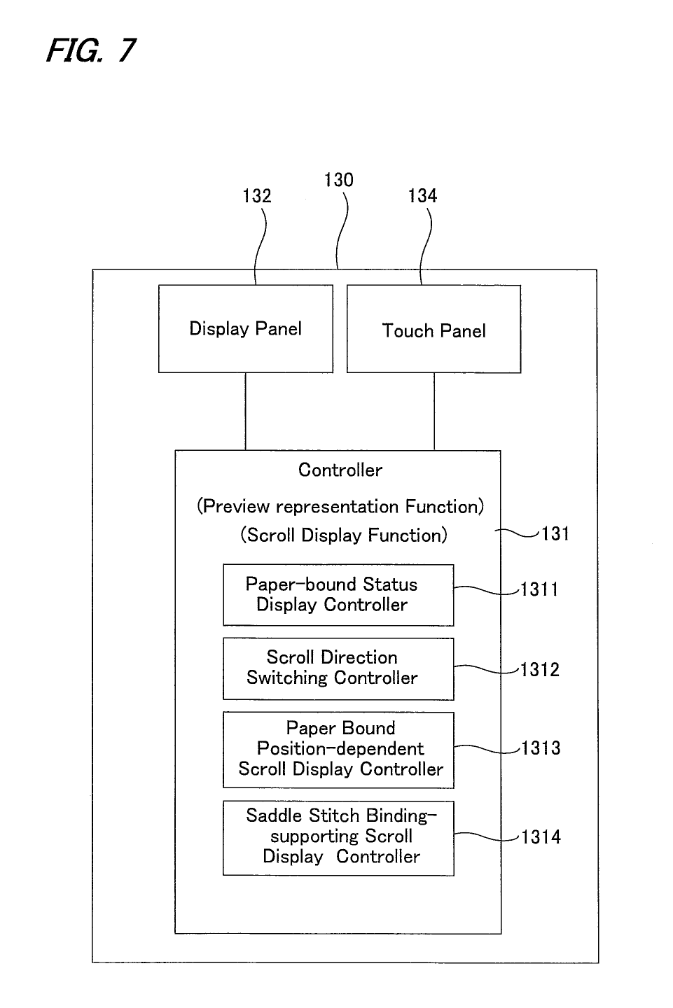

FIG. 7 is a block diagram showing the configuration of the touch panel display of the control unit of the image forming apparatus of the present embodiment.

Control unit 120 according to the present embodiment includes, in addition to the components described above, a controller 131 that controls the preview display function for performing preview display of multiple pages of document images on display panel 132 and the scroll display function for performing scroll display of multiple pages of document images given in preview representation, as shown in FIG. 7.

Controller 131 of touch panel display 130 functioning as a display control means includes a paper-bound status display controller 1311 and a scroll direction switching controller 1312.

When the printed paper (recording medium) is bound after document images are formed, paper-bound status display controller 1311 controls the preview frame including multiple page of preview images 135 to be displayed on display panel 132 such as that the page document images on display panel 132 are arrayed in either the vertical direction or the horizontal direction, depending on the binding position of the printed paper.

Scroll direction switching controller 1312 performs switching and control of the direction in which preview images 135 are scrolled in either the vertical direction or the horizontal direction with respect to display panel 132.

Controller 131 includes a paper bound position-dependent scroll display controller 1313 for scrolling preview images 135 in the direction that crosses the side edge along which the printed paper of preview images 135 displayed on display panel 132 is bound.

In other words, when the printed paper is bound along the side edge that extends in the vertical direction on display panel 132, paper bound position-dependent scroll display controller 1313 controls the direction of scrolling preview images 135 such as to be the direction crossing the side edge extending in the vertical direction, or to be the horizontal (left-and-right) direction on display panel 132. When the printed paper is bound along the side edge that extends in the horizontal direction on display panel 132, the direction of scrolling preview images 135 is controlled such as to be the vertical (top-and-down) direction on display panel 132.

Further, controller 131 includes a saddle stitch binding-supporting scroll display controller 1314 for scrolling preview images 135 in the direction crossing to the saddle binding line (the fold when the paper is folded along the saddle binding position) of the printed paper of preview images 135 displayed on display panel 132.

In other words, in the case where the printed paper is bound along the saddle binding line, when the saddle binding line extends in the vertical direction on display panel 132, saddle stitch binding-supporting scroll display controller 1314 controls the direction of scrolling preview images 135 such as to be the direction crossing the saddle binding line extending in the vertical direction, or to be the horizontal (left-and-right) direction on display panel 132. When the saddle binding line extends in the horizontal direction on display panel 132, the direction of scrolling preview images 135 is controlled such as to be direction crossing the saddle binding line extending the horizontal direction or the vertical (top-and-down) direction on display panel 132.

Now, the distinctive preview display of document images on touch panel display 130 will be specifically described with reference to the drawings.

Here, the following description will be given on a display style in which preview display of document images is performed using the whole touch panel display. However, preview display may be given in preview region 3000 (FIG. 4) or preview display may be given on the enlarged preview region 3000 with function selecting region 2000 (FIG. 4) displayed in icon mode, as in the forgoing description.

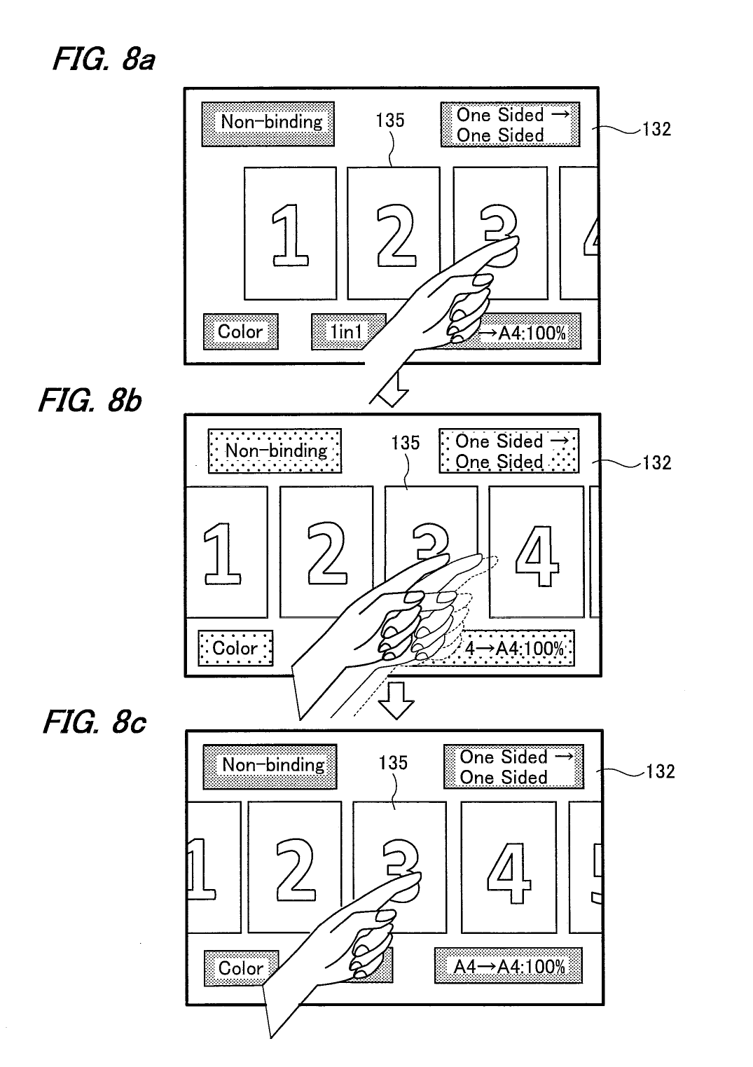

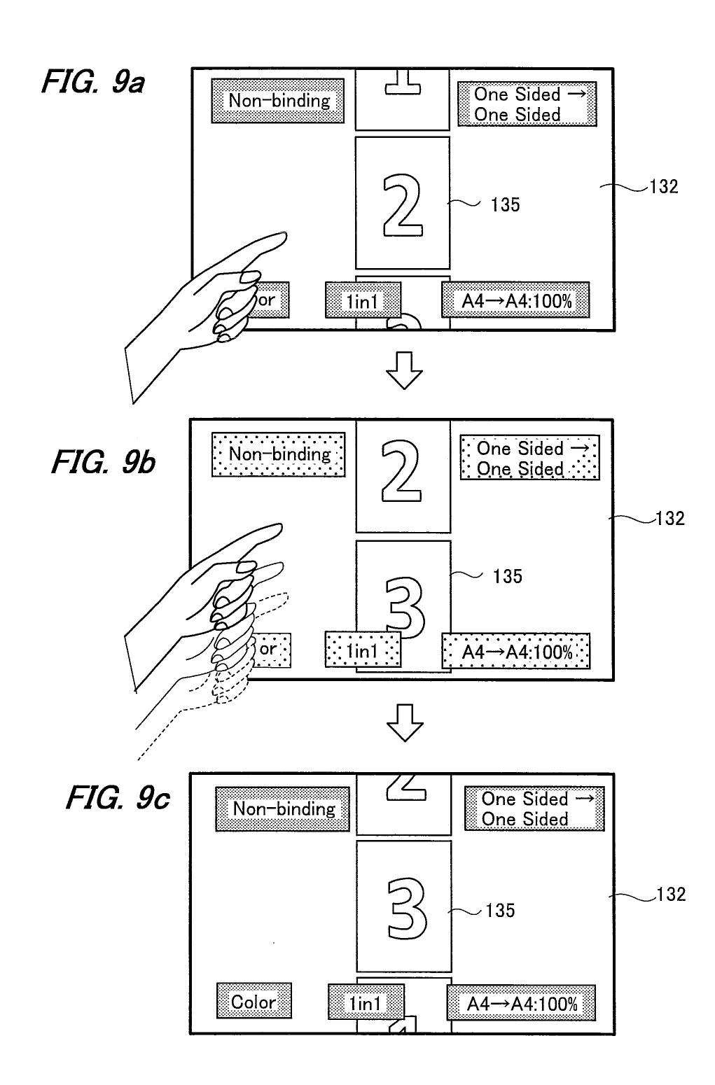

FIGS. 8a to 8c are illustrative views showing the states where document images are displayed laterally in preview representation on the touch panel display of the present embodiment. FIGS. 9a to 9c are illustrative views showing the states where document images are displayed vertically in preview representation on the touch panel display.

When the printing content is checked before printing in image forming apparatus 100, multiple pages of data to be printed are displayed on display panel 132 of touch panel display 130 in a preview form so that all the pages can be displayed as a whole.

When images of portrait documents are arranged laterally and displayed in preview representation in the preview display on touch panel display 130, the document images are scroll-displayed in ascending order (1, 2, 3, . . . ) from the left to the right on display panel 132, as shown in FIGS. 8a to 8c.

When images of portrait documents are arranged vertically and displayed in preview representation, the document images are scroll-displayed in ascending order (1, 2, 3, . . . ) from top to bottom on display panel 132, as shown in FIGS. 9a to 9c.

When the document images displayed on display panel 132 are scrolled, the finger is put in touch with one of the document images on display panel 132 and slid, as shown in FIGS. 8a to 8c and 9a to 9c, so that it is possible to scroll the images in the sliding direction.

Here, though in the present embodiment the document images are moved by scrolling on display panel 132, the movement of the document images in the indicated direction can be attained when the documents are shifted by switching the display content from one to another.

Next, the preview display of document images when the printed paper is to be bound will be described.

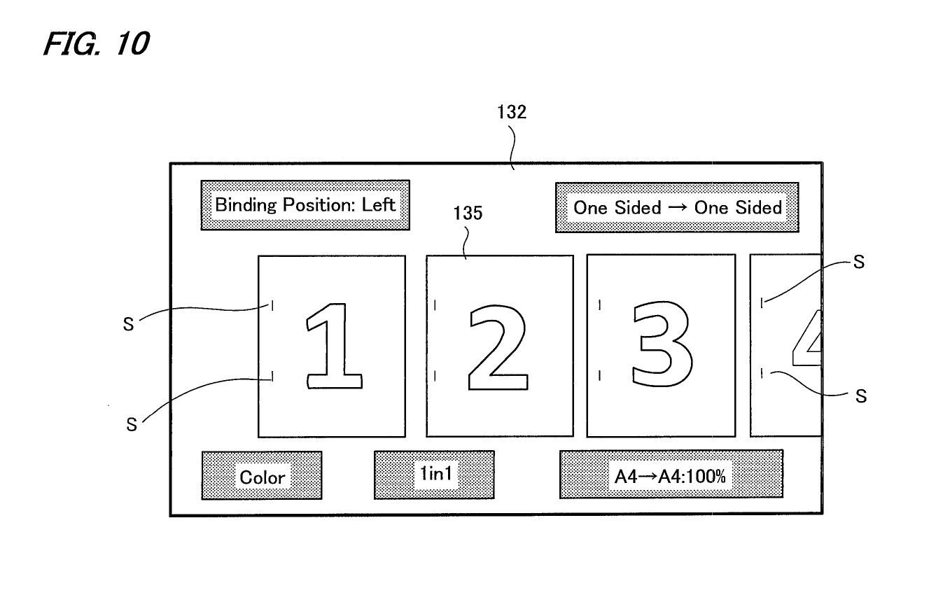

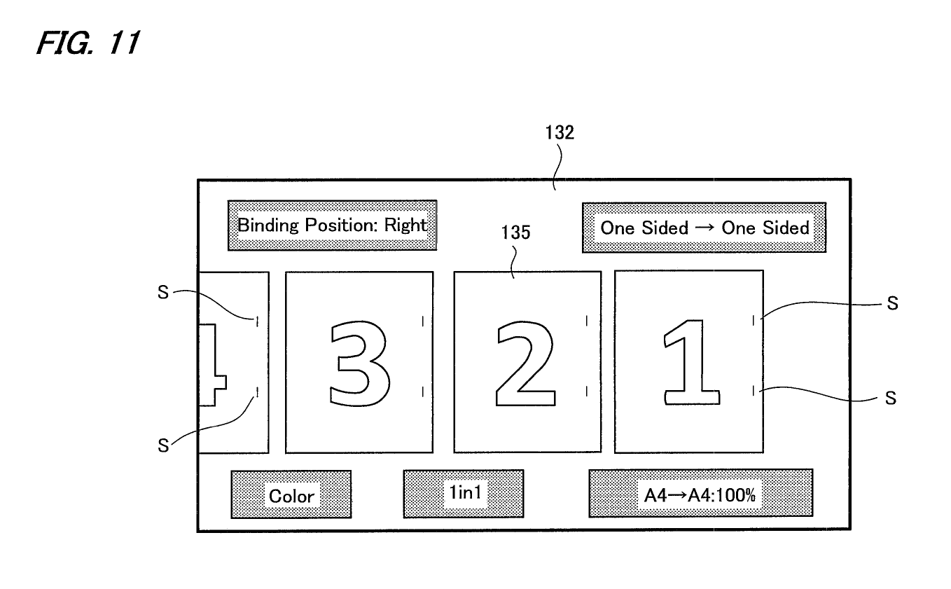

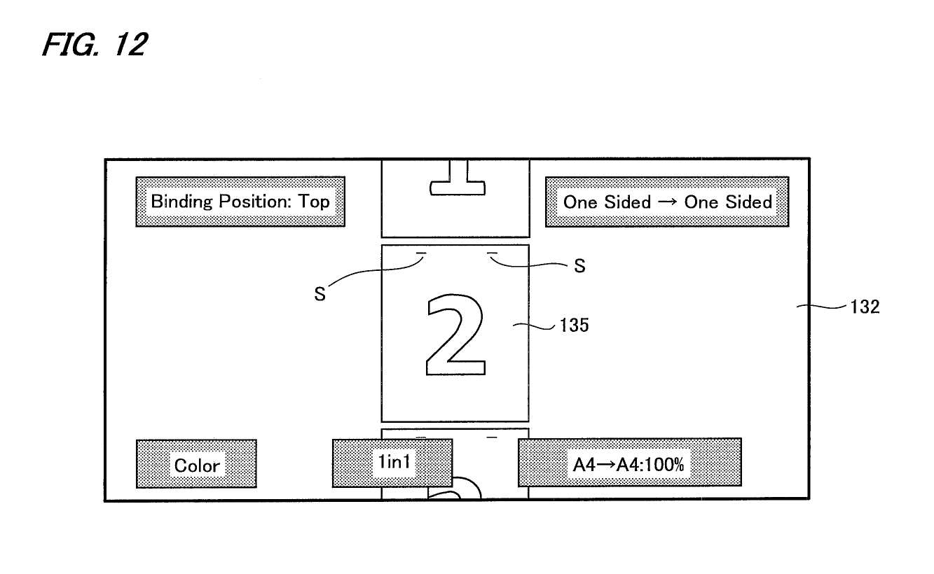

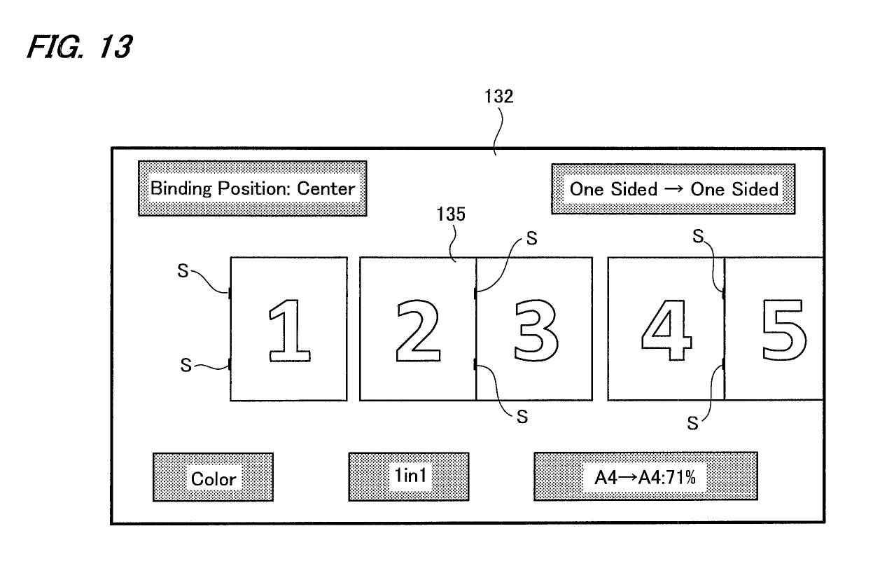

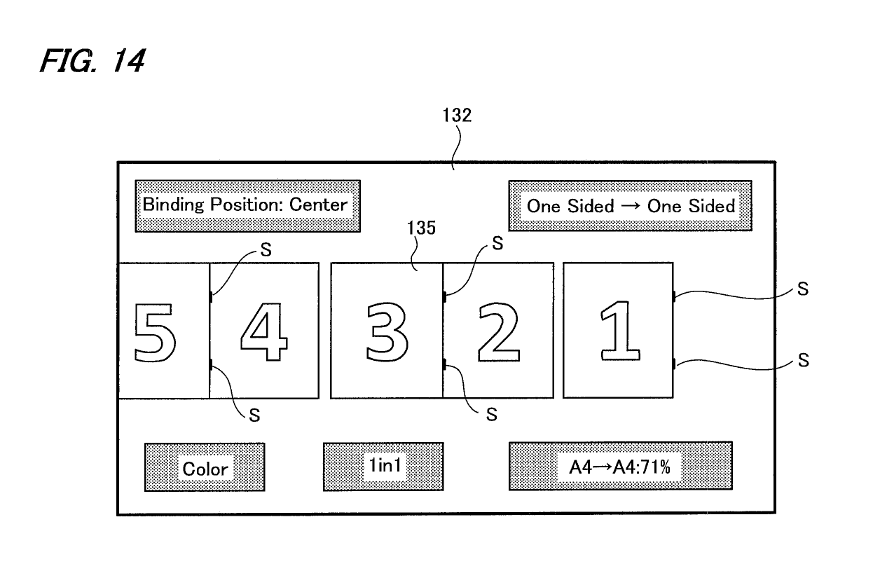

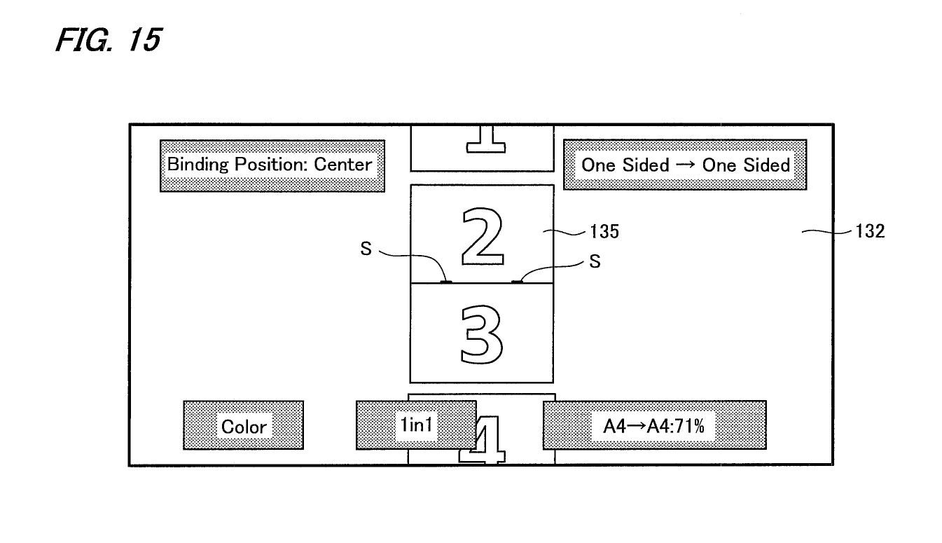

FIG. 10 is an illustrative view showing a state of document images in preview representation on the touch panel display of the present embodiment when the vertical side edge on the left side of the printed paper is bound. FIG. 11 is an illustrative view showing a state of document images in preview representation on the touch panel display when the vertical side edge on the right side of the printed paper is bound. FIG. 12 is an illustrative view showing a state of document images in preview representation on the touch panel display when the top horizontal edge of the printed paper is bound. FIG. 13 is an illustrative view showing a state of document images in preview representation on the touch panel display when the printed paper is bound along the vertical fold by saddle stitch binding and used as a left-bound booklet. FIG. 14 is an illustrative view showing a state of document images in preview representation on the touch panel display when the printed paper is bound along the vertical fold by saddle stitch binding and used as a right-bound booklet. FIG. 15 is an illustrative view showing a state of document images in preview representation on the touch panel display when the printed paper is bound along the horizontal fold by saddle stitch binding and used as a top-bound booklet.

In a case where the paper after printing in image forming apparatus 100 is bound along the vertical side edge on the left side, when images of portrait documents are displayed in preview representation, the document images are arranged laterally in ascending order (1, 2, 3, . . . ) from the left to the right on display panel 132 and displayed in a scrolling manner with binding positions S displayed next to the vertical side edge on the left side of each document image, as shown in FIG. 10.

On the other hand, in a case where the paper after printing is bound along the vertical side edge on the right side, when images of portrait documents are displayed in preview representation, the document images are arranged laterally in ascending order (1, 2, 3, . . . ) from the right to the left on display panel 132 and displayed in a scrolling manner with binding positions S displayed next to the vertical side edge on the right side of each document image, as shown in FIG. 11.

Further, in a case where the paper after printing is bound along the top horizontal edge, when images of portrait documents are displayed in preview representation, the document images are arranged vertically in ascending order (1, 2, 3, . . . ) from top to bottom on display panel 132 and displayed in a scrolling manner with binding positions S displayed next to the top horizontal edge of each document image, as shown in FIG. 12.

Here, the binding positions S on the printed paper shown in FIGS. 10, 11 and 12 are displayed as the positions for stapling.

As described above, since preview images of document images are adapted to be displayed on display panel 132 in accordance with the binding positions S on the paper after printing, by scrolling the document images horizontally when the binding position S is positioned along the left side edge/right side edge and by scrolling the document images vertically when the binding position S is positioned along the top edge it is possible to check the display content in a similar feeling as if pages are turned over by actually holding the bound edge of the printed matter.

In addition, as to the order in which document images to be displayed on display panel 132 in preview representation, the preview images of document images are arranged on display panel 132 from the left to the right when the binding position S of the printed matter is located along the left side edge while the preview images of document images are arranged on display panel 132 from the right to the left when the binding positions of the printed matter is located along the right side edge, whereby it is possible to check the display content in a similar feeling as if the actual printed matter is viewed.

In the present embodiment, when the printed matter is bound at the top right corner/top left corner, either the horizontal or veridical scrolling direction is possible to meet the optimal conditions depending on the content of documents, so that it is impossible to make an automatic determination. Accordingly, the direction of arranging the preview display of document images (the horizontal or vertical direction) may be selectively changed using a display direction changing switch or the like, depending on the content of documents.

Referring next to a flow chart, description will be made on how the arraying method and the method of arrangement of preview images of document images are determined depending on the location of binding positions S in the preview displayed on touch panel display 130.

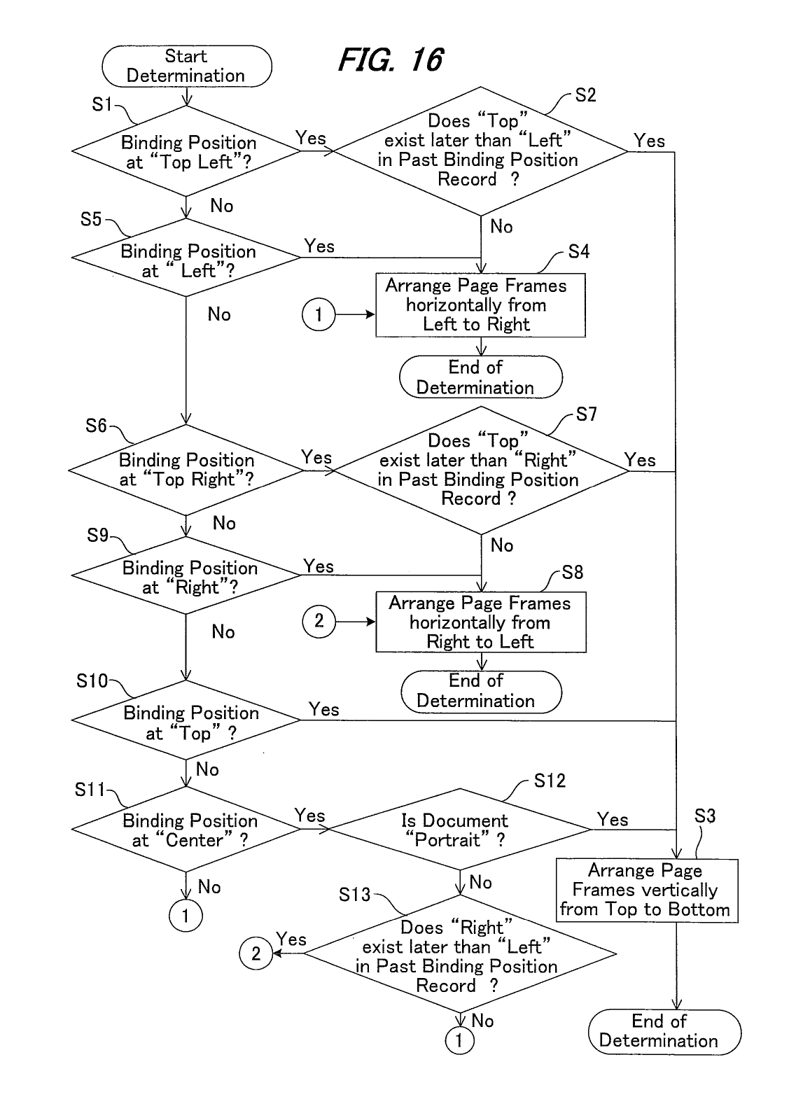

FIG. 16 is a flow chart showing the procedural sequence for determining the method of arraying document images and the method of arrangement, depending on the binding position S of the document images displayed on the touch panel display of the image forming apparatus according to the present embodiment.

In image forming apparatus 100, the preview display of document images to be printed, on the display panel 132 of touch panel display 130 is determined based on the operational flow shown in FIG. 16.

As shown in FIG. 16, when determination of the preview display is started, the binding position S after printing is determined first. At Step S1, it is determined whether the binding position S is located at the top left. When it is determined that the binding position S is located at the top left, it is determined whether top binding position S exists later than the existence of the left-side binding position S in the past binding position record (Step S2).

When it is determined that top binding position S exists later than the existence of the left-side binding position in the past binding position record at Step S2, the page display frames of the document images are arranged vertically from top to bottom on display panel 132 as shown in FIG. 12, by paper-bound status display controller 1311 (FIG. 7) (Step S3), and then the document images are rendered in the order of arrangement to thereby complete preview display determination.

On the other hand, when it is determined at Step S2 that top binding position S does not exist later than the existence of the left-side binding position in the past binding position record, the page display frames of the document images are arranged horizontally from the left to the right on display panel 132 as shown in FIG. 10 by paper-bound status display controller 1311 (FIG. 7) (Step S4), and then the document images are rendered in the order of arrangement to thereby complete preview display determination.

Further, when it is determined at Step S1 that the binding position S is not located at the top left, it is determined whether the binding position S is located on the left side (Step S5).

When it is determined at Step S5 that the binding position S is located on the left side, the page display frames of the document images are arranged horizontally from the left to the right on display panel 132 as shown in FIG. 10 by paper-bound status display controller 1311 (FIG. 7) (Step S4), and then the document images are rendered in the order of arrangement to thereby complete preview display determination.

On the other hand, when it is determined at Step S5 that the binding position S is not located on the left side, it is determined whether the binding position S is located at the top right (Step S6).

When it is determined at Step S6 that the binding position S is located at the top right, it is determined whether top binding position S exists later than the existence of the right-side binding position S in the past binding position record (Step S7).

When it is determined that top binding position S exists later than the existence of the right-side binding position in the past binding position record at Step S7, the page display frames of the document images are arranged vertically from top to bottom on display panel 132 as shown in FIG. 12 by paper-bound status display controller 1311 (FIG. 7) (Step S3), and then the document images are rendered in the order of arrangement to thereby complete preview display determination.

On the other hand, when it is determined at Step S7 that top binding position S does not exist later than the existence of the right-side binding position in the past binding position record, the page display frames of the document images are arranged horizontally from the right to the left on display panel 132 as shown in FIG. 11 by paper-bound status display controller 1311 (Step S8), and then the document images are rendered in the order of arrangement to thereby complete preview display determination.

Further, when it is determined at Step S6 that the binding position S is not located at the top right, it is determined whether the binding position S is located on the right side (Step S9).

When it is determined at Step S9 that the binding position S is located on the right side, the page display frames of the document images are arranged horizontally from the right to the left on display panel 132 as shown in FIG. 11 by paper-bound status display controller 1311 (Step S8), and then the document images are rendered in the order of arrangement to thereby complete preview display determination.

On the other hand, when it is determined at Step S9 that the binding position S is not located on the right side, it is determined whether the binding position S is located on the upper side (Step S10).

When it is determined at Step S10 that the binding position S is located on the upper side, the page display frames of the document images are arranged vertically from top to bottom on display panel 132 as shown in FIG. 12 by paper-bound status display controller 1311 (Step S3), and then the document images are rendered in the order of arrangement to thereby complete preview display determination.

On the other hand, when it is determined at Step S10 that the binding position S is not located on the upper side, it is determined whether the binding S is located along the center fold (Step S11).

When it is determined that the binding S is located along the center fold at Step S11, it is determined whether the documents are positioned portrait (Step S12).

When it is determined that the documents are positioned portrait at Step S12, the page display frames of the document images are arranged vertically from top to bottom on display panel 132 as shown in FIG. 15 by paper-bound status display controller 1311 (Step S3), and then the document images are rendered in the order of arrangement to thereby complete preview display determination.

On the other hand, when it is determined at Step S12 that the documents are not positioned portrait, it is further determined whether right-side binding position S exists later than the existence of the left-side binding position S in the past binding position record (Step S13).

When it is determined that right-side binding position S exists later than the existence of the left-side binding position in the past binding position record at Step S13, the control goes to Step S8, where the page display frames of the document images are arranged horizontally from the right to the left on display panel 132 as shown in FIG. 14, by paper-bound status display controller 1311, and then the document images are rendered in the order of arrangement to thereby complete preview display determination.

On the other hand, when it is determined at Step S13 that right-side binding position S does not exist later than the existence of the left-side binding position in the past binding position record, the control goes to Step S4, where the page display frames of the document images are arranged horizontally from the left to the right on display panel 132 as shown in FIG. 13 by paper-bound status display controller 1311, and then the document images are rendered in the order of arrangement to thereby complete preview display determination.

When it is determined at Step S11 that the binding position S is not at the center fold, the control goes to Step S4, where the page display frames of the document images are arranged horizontally from the left to the right on display panel 132 as shown in FIG. 10 by paper-bound status display controller 1311, and then the document images are rendered in the order of arrangement to thereby complete preview display determination.

In the above way, the document images to be printed are examined as to the method of arraying and the method of arrangement on touch panel display 130, and are displayed in preview representation on display panel 132 by paper-bound status display controller 1311.

Preview images 135 displayed on display panel 132 are displayed in a scrolling manner in conformity with the binding position S of the paper by paper bound position-dependent scroll display controller 1313(FIG. 7) and saddle stitch binding-supporting scroll display controller 1314(FIG. 7).

Further, the direction of scrolling preview images 135 is switched by scroll direction switching controller 1312, in accordance with the direction of preview images 135 being arranged (the vertical direction or horizontal direction).

As described heretofore, touch panel display 130 functioning as a display controller capable of performing preview representation of multiple pages of document images on display panel 132 is equipped with display controller 1311 that displays preview images 135 of multiple pages of document images on display panel 132 along the vertical or horizontal direction with respect to display panel 132 in accordance with the binding position S of the printed paper and scroll direction switching controller 1312 that switches the direction in which preview images 135 are scrolled with respect to display panel 132 between the vertical direction and the horizontal direction. As a result, it is possible for the user to see preview images 135 by moving their gaze in the same manner (for example, in a state where the printed matter is given as an expanded zigzag fold) as if the user actually turns over the page of the printed matter with the binding position S fixed, hence easily imagine the condition of the finished printout.

Further, since touch panel display 130 includes paper bound position-dependent scroll display controller 1313 that scrolls preview images 135 in the direction that crosses the side edge of preview images 135 displayed on display panel 132, along which the paper is bound, it is possible for the user to see preview images 135 by moving their gaze in the same manner as if the user actually turns over the page of the printed matter, hence easily imagine the condition of the finished printout.

Further, since touch panel display 130 includes a saddle stitch binding-supporting scroll display controller 1314 that scrolls preview images 135 in the direction crossing the center fold lines of preview images 135 of the paper displayed on display panel 132, it is possible for the user to see preview images 135 by moving their gaze in the same manner as if the user actually turns over the page of the printed matter, hence easily imagine the condition of the finished printout.

Since touch panel display 130 is made up of display panel 132 of a liquid crystal panel etc., and touch panel 134 that is laid over display panel 132 to detect the position pressed by the fingers of the user and recognize the touch control in display control by user's fingers and since this touch panel 134 is provided with a function of scrolling preview images 135 in accordance with the desired direction in which the user indicates to scroll preview images 135 with the finger, it is possible to easily perform scrolling control in a similar feeling as if pages are actually turned over.

The above embodiment was described taking an example in which control unit 120 of the present invention is applied to image forming apparatus 100 shown in FIG. 1. However, as long as it is an image forming apparatus in which document images are presented in preview representation on the display panel or the like before printing so as to enable conformation of the printed condition, the invention can be developed to any other image forming apparatus and the like, not limited to the image forming apparatus and copier having the configuration described above.

Though in the above description, preview images 135 displayed on touch panel display 130 are scrolled, the preview images may be changed over in display screen unit (every multiple pages of preview images).

Further, though a flick control with the finger of the operation is used as the technique to scroll preview images 135 displayed on touch panel display 130, keys for scrolling up, down, left and right may be displayed on touch panel display 130 so as to allow the operator to touch these keys for scrolling.

Having described heretofore, the present invention is not limited to the above embodiment, various changes can be made within the scope of the appended claims. That is, it is apparent that various kinds of variations and modified examples will occur to those skilled in the art within the scope of the appended claims. That is, any embodied mode obtained by combination of technical means modified as appropriate without departing from the spirit and scope of the present invention should be included in the technical art of the present invention.

What is claimed is:

1. An image display control device comprising:
a control screen on which document images are presented in preview representation; and,
a display controller that has a function of presenting plural pages of document images on the control screen in preview representation and a function of displaying the plural pages of document images presented in preview representation in a vertically or horizontally scrolling manner,
characterized in that the display controller includes:
a function by which, when a plurality of pages of recording mediums with the plural pages of document images recorded thereon are bound, the plural preview images of the plural pages of document images displayed on the control screen are arranged vertically or horizontally with respect to the control screen and displayed, in accordance with the binding position of the recording medium; and
a function of switching the scrolling direction of the plural preview images between the vertical direction and the horizontal direction with respect to the control screen.

2. The image display control device according to claim 1, wherein the display controller includes a function of scrolling the preview images in the direction crossing the side edge along which the recording mediums displayed as the preview images on the control screen are bound.

3. The image display control device according to claim 1, wherein the display controller includes a function of scrolling the preview images in the direction crossing the saddle binding line of the recording mediums displayed as the preview images on the control screen.

4. The image display control device according to claim 1, wherein the control screen includes a touch-control detector that detects a touch control on the control screen by the finger of a user, and,
the touch-control detector has a function of scrolling the preview images in accordance with the indication of the scrolling direction of the preview images by the finger of the user.

5. The image display control device according to claim 2, wherein the control screen includes a touch-control detector that detects a touch control on the control screen by the finger of a user, and,
the touch-control detector has a function of scrolling the preview images in accordance with the indication of the scrolling direction of the preview images by the finger of the user.

6. The image display control device according to claim 3, wherein the control screen includes a touch-control detector that detects a touch control on the control screen by the finger of a user, and,
the touch-control detector has a function of scrolling the preview images in accordance with the indication of the scrolling direction of the preview images by the finger of the user.

7. An image forming apparatus comprising: an image display control device, characterized in that
the image display control device includes:
a control screen on which document images are presented in preview representation; and,
a display controller that has a function of presenting plural pages of document images on the control screen in preview representation and a function of displaying the plural pages of document images presented in preview representation in a vertically or horizontally scrolling manner, and,
the image display control device is the image display control device according to claim 1.
